(19) United States
(12) Patent Application Publication
(10) Pub. No.: US 2008/0022568 A1
(43) Pub. Date: Jan. 31, 2008

(54) DESK ACCESSORY WITH DISPLAY

(76) Inventor: Bonni Shevin Sandy, Morton Grove, IL (US)

Correspondence Address: PERKINS COIE LLP, POST OFFICE BOX 1208, SEATTLE, WA, 98111-1208, US

(21) Appl. No.: 11/847,058

(22) Filed: Aug. 29, 2007

(51) Int. Cl. B43M 17/00

(52) U.S. Cl. 40/358

(57) ABSTRACT

A combination stapler and tape dispenser device is adapted to lay prone on a bottom surface or to allow it to stand up on at least one end. An analog or digital display on the device can pivot or rotate and is typically weighted so that it remains upright, and hence easily readable, regardless of the orientation of the device. The display may be at a front end of the device for greater visibility when the device is standing up.

### BACKGROUND OF THE INVENTION

The field of the invention is desk and office products and accessories. A multipurpose device is disclosed useful for conveniently holding or storing multiple useful desk or office objects or tools. Potential for desk clutter and misplacing objects is reduced.

### SUMMARY OF THE INVENTION

In one design, a base or primary structure is provided in the form of a stapler. The base may also include a tape dispenser. The base is adapted to allow it to stand up on at least one end. An analog or digital display is attached to the base. The display can pivot or rotate relative to the base, and is typically weighted so that it remains upright, and hence easily readable, regardless of the orientation of the base.

Other objects, features and advantages will be apparent from the following detailed description, which shows alternative embodiments. The drawings are provided to show an example and should not be understood as limitations on the scope of the invention. The invention resides as well in sub combinations of the elements described and shown.

### BRIEF DESCRIPTION OF THE DRAWINGS

FIG. 1 is a top, front and left side perspective view of a new office product or desk accessory or device.

FIG. 2 is a bottom, rear and right side perspective view of the device shown in FIG. 1.

FIG. 3 is a left side view.

FIG. 4 is a top view.

### DETAILED DESCRIPTION OF THE DRAWINGS

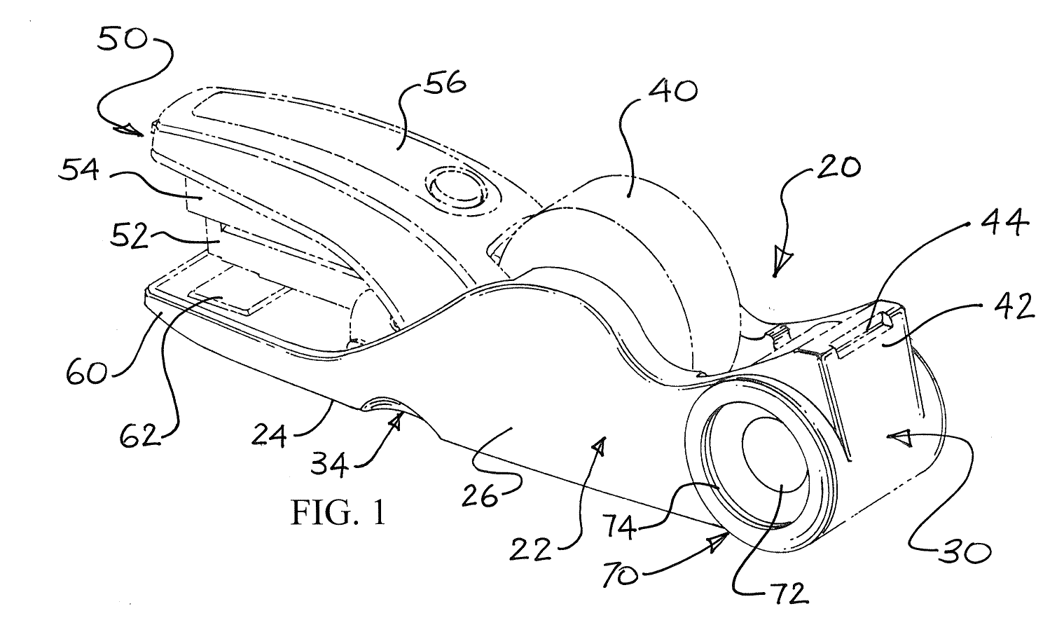

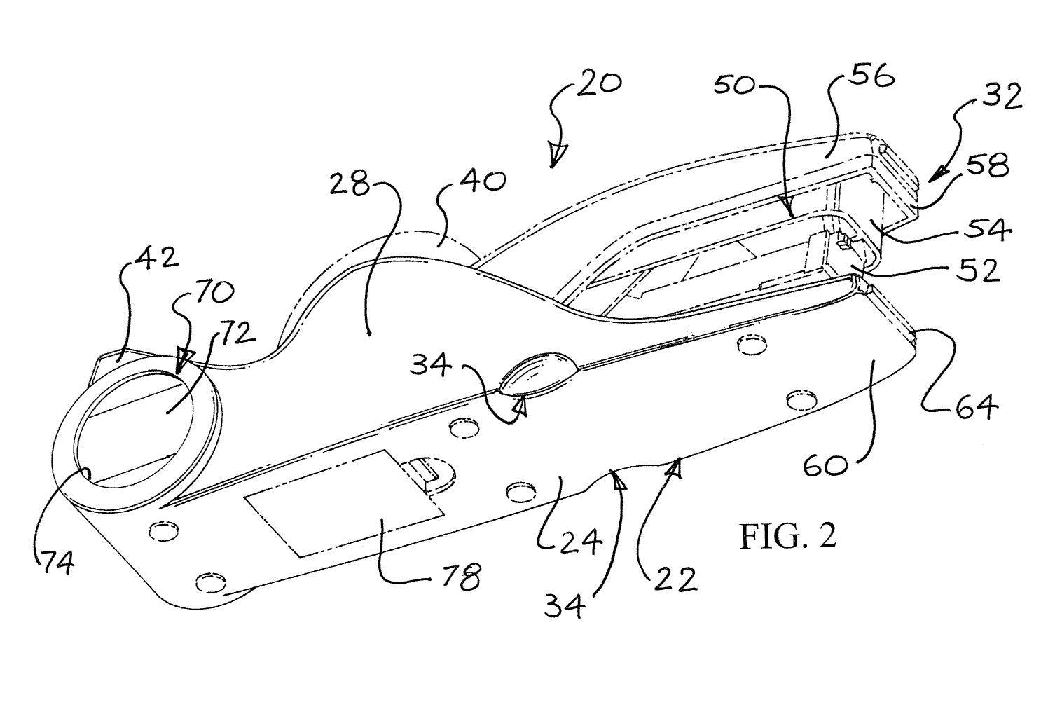

As shown in the drawings, a desk accessory or device 20 has a base 22. The base 22 has a generally elongated or rectangular profile, as shown in FIG. 2. As shown in FIG. 1, the base 22 has a generally flat front surface 30. As shown in FIG. 2, the base also has generally flat rear surfaces 58 and 64. Consequently, the device 20 can lay flat on a bottom surface 24, or it may lay generally flat on the left side 26 or the right side 28. It may be also stand up, with the front end 30 or the flat rear surfaces 58 and 64 resting on a desk or other platform. The base may be advantageously made of metal or plastic. Finger recesses 34 may be provided at a generally central location on the base 22, to allow the base to be securely grasped.

The device may include desk tools or objects, such as a stapler generally designated at 50, and an adhesive tape spool 40. These elements are attached to or supported on the base 22. Other desk objects may also optionally be included, in addition to, or in place of, the stapler and/or the tape spool 40. For example, a paper clip holder, a flag or Post-It® note pad, pen or pencil/holder, etc. may be used. In the example shown in the drawings, a stapler 50 is pivotally attached onto the base 22 and includes a magazine 52 for holding strips of staples, a plunger 54 and a handle 56 on the plunger 54. A plunger pad 62 is attached onto a foot 60 of the base 22, to crimp staples as they are pressed out of the magazine by the plunger.

In designs including a tape dispenser, as shown in FIG. 1, the spool 40 of tape is supported on a roller rotatably held onto or into the base 22. A tape cutter 44 is attached onto an upper end 42 of the front surface 30, to allow the tape to be conveniently cut.

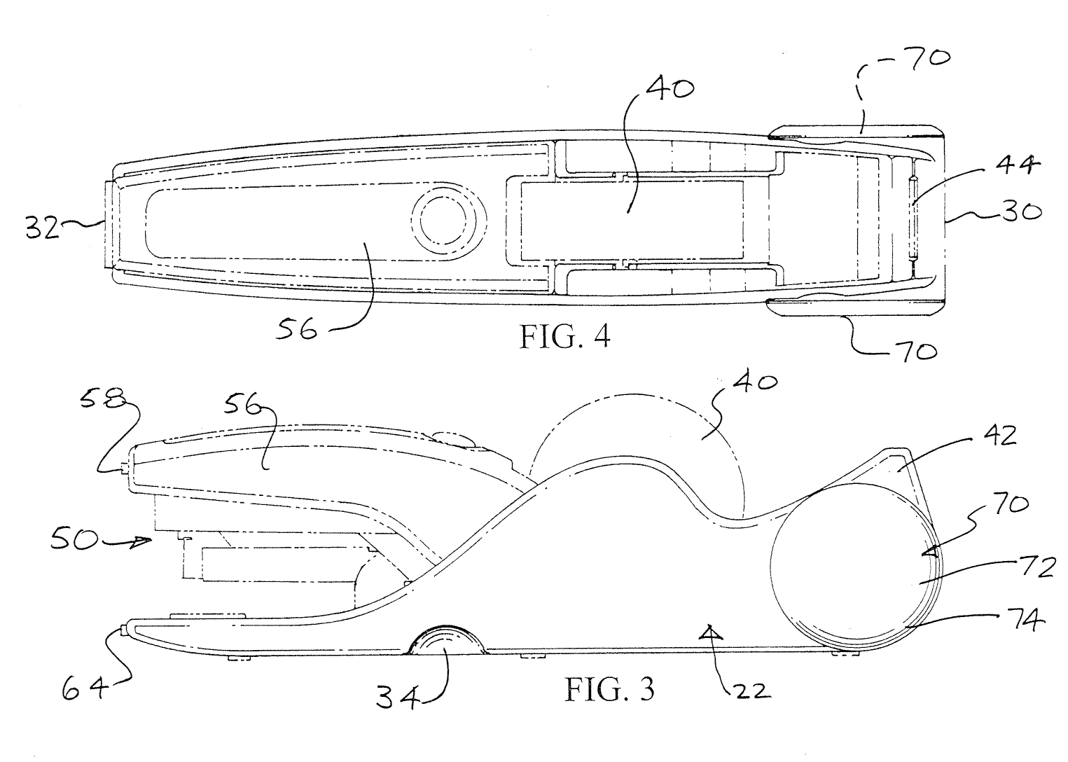

As shown in FIGS. 1-4, a display assembly 70 is attached to or part of the base 22. The display assembly 70 includes a display 72 supported on or within a display bearing 74 and designed so that the display remains upright (relative to gravity) regardless of the orientation of the base. The display 72 may be an LED, LCD or other type of electronic numeric or alpha-numeric display. The display 72 may also be an analog display, such as an analog clock. The display 72 shown in the drawings is round. However, other shapes of displays may of course be used, such as triangular, square, or other polygonal shapes, or even irregular shapes. The display 72 may be provided with a weighted element at or near the bottom end of the display, so that with the display free to rotate within the bearing 74, gravity acts to keep the display upright.

Various types of display bearing may be used. For example, the display bearing 74 may be liquid filled, so that the display floats within the display bearing. This design may use a self contained and sealed display element having a lifetime battery. Alternatively, mechanical bearings, such as ball, pin or roller bearings may be used, instead of a liquid bearing element. The weighted element may optionally be located on an inner race of the bearing supporting the display, rather than on the display itself. In designs where the display is battery powered, the batteries, such as watch batteries, may be contained within the display. Alternatively, larger batteries, such as AA or AAA batteries, etc., may be contained in a battery compartment 78 in the base, as shown in FIG. 2. The batteries in the battery compartment, if used, are electrically connected to the display 72 via wires, and optionally slip rings, or equivalent electrically conductive/rotating elements. The display assembly 70, including the display 72 and the bearing 74, may be provided as unit or sub-assembly that is attached onto or into the base 22. Alternatively, these elements may be assembled individually onto the base. Although the display assembly 70 is shown at the front end of the device 20, it may also be located more centrally as well, for example adjacent to the spool of tape. In addition, more than one display may be used. For example, a first display may be provided on the left side 26 of the base, and a second display (optionally displaying different information) may be provided on the right side of the base. More than one display may be provided on one side of the base.

In use, the device may be placed prone or upright on a desk. Regardless of the orientation of the base, the display(s) 72 on the device remain upright, as the bottom of the display rotates downwardly under force of gravity. As a result, the display is always easily readable, regardless of how the device is oriented.

Thus, a novel desk accessory has been shown and described. Various substitutions and changes may of course be made without departing from the spirit and scope of the invention. The invention, therefore, should not be restricted, except by the following claims, and their equivalents.

1. An accessory comprising:
an elongated base having a generally flat bottom surface;
a stapler attached to the base;
a tape spool rotatably supported on or in the base;
a tape cutter adjacent a first end of the base; and
a display rotatably supported on the base and adapted to remain upright relative to gravity regardless of the orientation of the base.

2. The accessory of claim 1 wherein the display has a weighted lower end and the display is free floating in a liquid filled container attached to the base.

3. The accessory of claim 1 with the display attached to the base via a bearing, and with the center of gravity of the display causing the display to remain in the upright orientation.

4. The accessory of claim 1 with the base having substantially flat bottom, front and rear surfaces, and with the base supportable on a flat desk surface in a prone position on the bottom surface and also supportable in a standing position on the front or rear surfaces.

5. The accessory of claim 4 with the display adjacent to the front surface.

6. A combination stapler and tape dispenser device comprising:
a base having a substantially rectangular bottom surface;
with the base including a foot section having a generally flat first surface;
a stapler mechanism attached to the base and including a handle having a generally flat second surface, with the first and second surfaces substantially aligned in a plane, to allow the device to stand up on the first and second surfaces;
a tape spool on the base;
a tape cutter adjacent to a front end of the base;
a display rotatably supported adjacent to the front end of the base, with the display adapted to rotate into and remain in an upright position relative to gravity, regardless of the orientation of the base.

7. The device of claim 6 wherein the display has a diameter greater than 50% of the height of the device.

8. The device of claim 6 wherein the base is adapted to hold a tape spool having a maximum diameter D, and the display has a diameter of 50%-100% of D.

9. The device of claim 6 with the base having substantially flat left and right sides, and with the display on the left or right side of the base.

10. A combination stapler and tape dispenser device comprising:
a stapler base;
a stapler assembly pivotally attached to the stapler base;
a spool of tape on the stapler base or on the stapler assembly;
a display on the stapler base;
means for maintaining the display in an upright orientation relative to gravity regardless of the position of the stapler base.
